(19) United States
(12) Patent Application Publication
(10) Pub. No.: US 2003/0165161 A1
(43) Pub. Date: Sep. 4, 2003

(54) Synchronization of data packet numbers in packet-switched data transmission

(75) Inventors: Juha Kalliokulju, Vesilahti (FI); Sinikka Sarkkinen, Kangasala (FI)

Correspondence Address: Crawford Maunu PLLC, 1270 Northland Drive, Suite 390, St. Paul, MN, 55120, US

(73) Assignee: Nokia Corporation

(21) Appl. No.: 10/365,869

(22) Filed: Feb. 13, 2003

Related U.S. Application Data
(63) Continuation of application No. PCT/FI01/00707, filed on Aug. 10, 2001.

(30) Foreign Application Priority Data
Aug. 14, 2000 (FI) 20001791

(51) Int. Cl. H04J 3/16

(52) U.S. Cl. 370/466; 370/469

(57) ABSTRACT

A method for acknowledged transmission of data packets in a packet-switched telecommunications system. A data packet number is defined for the convergence protocol packets to be transmitted by means of sending and receiving counters which are synchronized with each other, in which case the transmitted convergence protocol packets are acknowledged with the counter values. Convergence protocol packets containing only user data are used in the data transmission between the sender and the receiver. If the counters become asynchronous, convergence protocol packets containing a packet data number are sent, and the number of these convergence protocol packets is indicated to the receiver. The counters are synchronized on the basis of the data packet numbers of the convergence protocol packets. After the number of convergence protocol packets with a data packet number have been sent, transmission of convergence protocol packets containing only user data is continued.

This application is a Continuation of International Application PCT/FI01/00707 filed on Oct. 8, 2001, which designated the U.S. and was published under PCT Article 21(2) in English.

### BACKGROUND OF THE INVENTION

The invention relates to packet-switched data transmission, and more precisely, to synchronization of data packet numbers, particularly in connection with acknowledged data transmission.

In addition to circuit-switched services, which are typically speech services, the third-generation mobile communication systems, which are also called e.g. the UMTS (Universal Mobile Telecommunications System) and the IMT-2000 (International Mobile Telephone System), will offer packet-switched services like the GPRS (General Packet Radio Service) packet radio network designed for the GSM system. Packet-switched data transmission enables the use of various data services through a mobile station, and allocation of resources of the mobile communication system, particularly those of the radio interface, to each user according to the need.

In packet-switched data transmission we can employ reliable, i.e. acknowledged, transmission or unreliable, i.e. unacknowledged, transmission. In acknowledged data transmission the receiver sends an acknowledgement of received data packets PDU (Protocol Data Unit) to the sender, and thus the sender can retransmit lost or damaged packets. The sender sets the data packets PDU in a buffer to wait for an acknowledgement of received packets or for a request to retransmit a lost or a damaged data packet. The transmitted data packets can be removed from the buffer as an acknowledgement of received data packets is received from the receiver.

To allow both the sender and the receiver to identify data packets that are to be acknowledged or requested again, the packets have to be identified in some way. This is done by defining a 16-bit data packet number, i.e. a PDCP-PDU number, for each data packet using the convergence protocol layer PDCP (Packet Data Convergence Protocol) of the data packet protocol. Transmission of this PDCP-PDU number with each data packet PDCP-PDU would increase the load in data transmission because two extra bytes would be transmitted in each data packet. For this reason, data packets are acknowledged in normal acknowledged data transmission on the basis of RLC numbering in an RLC layer (Radio Link Control) below the PDCP layer and acknowledgment of these numbers, in which case it is unnecessary to transmit PDCP-PDU numbers.

In some situations, e.g. during internal handover (SRNS relocation, Serving Radio Network Subsystem) between radio network subsystems of the UMTS, the RLC layer cannot, however, guarantee reliable acknowledgement of all data packets. For this reason, an arrangement known as virtual data packet numbering has been developed for the data packet protocol of the UMTS to maintain data packet numbering in the PDCP layer by means of counters. Both the transmitting PDCP and the receiving PDCP monitor the data packets to be transmitted by means of counters, and the receiving PDCP acknowledges received data packets by means of the counter reading, preferably in a manner corresponding to normal acknowledged data transmission, in which case data packet numbers need not be transmitted with the data packets. In theory, this also enables acknowledged data transmission by means of PDCP-PDU data packets which include no header field or data packet numbers, i.e. by means of PDCP-No-Header-PDUs. In that case all the data to be transmitted in the PDCP-PDU data packets consist of payload, i.e. comprise only user data received from the upper protocol layer.

The problem related to the arrangement described above is reconfiguration of a radio bearer RB which is defined to use the above-mentioned PDCP-No-Header-PDU data packets in acknowledged data transmission. The radio bearer has to be reconfigured e.g. during an internal handover between radio network subsystems of the UMTS, in which case synchronization of the data packet counters of the transmitting PDCP and the receiving PDCP may be lost. The PDCP-No-Header-PDU data packets defined for the radio bearer do not contain any control information for synchronizing the counters. In practice it is thus impossible to guarantee acknowledged data transmission on connections that use PDCP-No-Header-PDU data packets and virtual data packet numbering.

### BRIEF DESCRIPTION OF THE INVENTION

An object of the invention is to provide an improved method and an apparatus implementing the method to minimize the above-mentioned disadvantages. The objects of the invention are achieved with a method and an arrangement which are characterized by what is disclosed in the independent claims. The preferred embodiments of the invention are disclosed in the dependent claims.

The invention is based on the following idea: if the above-mentioned data packet counters become asynchronous for some reason, convergence protocol packets including a data packet number, i.e. PDCP-SeqNum-PDUs, are sent and the receiver is informed of the number of convergence protocol packets by some mechanism. The data packet counters are synchronized on the basis of the data packet numbers included in the convergence protocol packets, and after the predetermined number of convergence protocol packets (PDCP-SeqNum-PDU) including the data packet number have been sent, transmission of convergence protocol packets (PDCP-No-Header-PDU) containing only user data is continued. Since the receiving PDCP is informed of how many PDCP-SeqNum-PDUs are to be transmitted, it can prepare for receiving PDCP-No-Header-PDUs again at the right moment.

According to a preferred embodiment of the invention, the number of PDCP-SeqNum-PDUs to be transmitted is determined and indicated to the receiver by means of signalling in accordance with a radio resource control protocol (RRC), which defines the radio bearer. According to a second preferred embodiment, this number is determined according to a predetermined default value. According to a third embodiment, the number of PDCP-SeqNum-PDUs to be transmitted is determined in the sender's convergence protocol layer, and during transmission the last PDCP-SeqNum-PDU to be transmitted is indicated to the sender by at least one predetermined bit included in the header field of the convergence protocol packet in question.

An advantage of the method according to the invention is that it also enables acknowledged data transmission on connections on which PDCP-No-Header-PDU data packets and virtual data packet numbering are to be used. A further advantage is that radio resources can be used more efficiently because data packets that do not contain an additional header field or data packet numbering field can be used on acknowledged connections, too. An advantage of an embodiment of the invention is that the number of PDCP-SeqNum-PDUs to be sent can be defined separately for each radio bearer, which enables even more flexible utilization of radio resources.

### BRIEF DESCRIPTION OF THE DRAWINGS

The invention will be described in greater detail by means of preferred embodiments with reference to the accompanying drawings, in which

FIG. 1 is a block diagram of the structure of the UMTS system;

FIG. 2 illustrates a protocol stack used for transmitting user data in the UMTS;

FIGS. 3a, 3b and 3c illustrate the structure of different data packets of the PDCP layer;

FIG. 4 is a block diagram illustrating a functional model of the PDCP layer;

FIG. 5 is a signalling chart illustrating acknowledged data transmission and acknowledgement of data packets in PDCP data transmission;

FIG. 6 is a signalling chart illustrating acknowledged data transmission which utilizes virtual data packet numbering, and acknowledgement of data packets in PDCP data transmission; and

FIG. 7 is a flow chart illustrating synchronization of data packet counters according to the invention.

### DETAILED DESCRIPTION OF THE INVENTION

In the following, the invention will be explained using as an example a packet radio service of the UMTS system, particularly internal handover between radio network subsystems of the UMTS (so called SRNS Relocation). However, the invention is not limited to the UMTS system, but may be applied to any packet-switched data transmission method in which virtual data packet numbering is used as will de described below. Consequently, the invention can be applied in acknowledged mode handover between the UMTS and the GPRS, for example, in which case the term receiving PDCP used in this description can be replaced with the corresponding function of the GPRS, i.e. SNDCP.

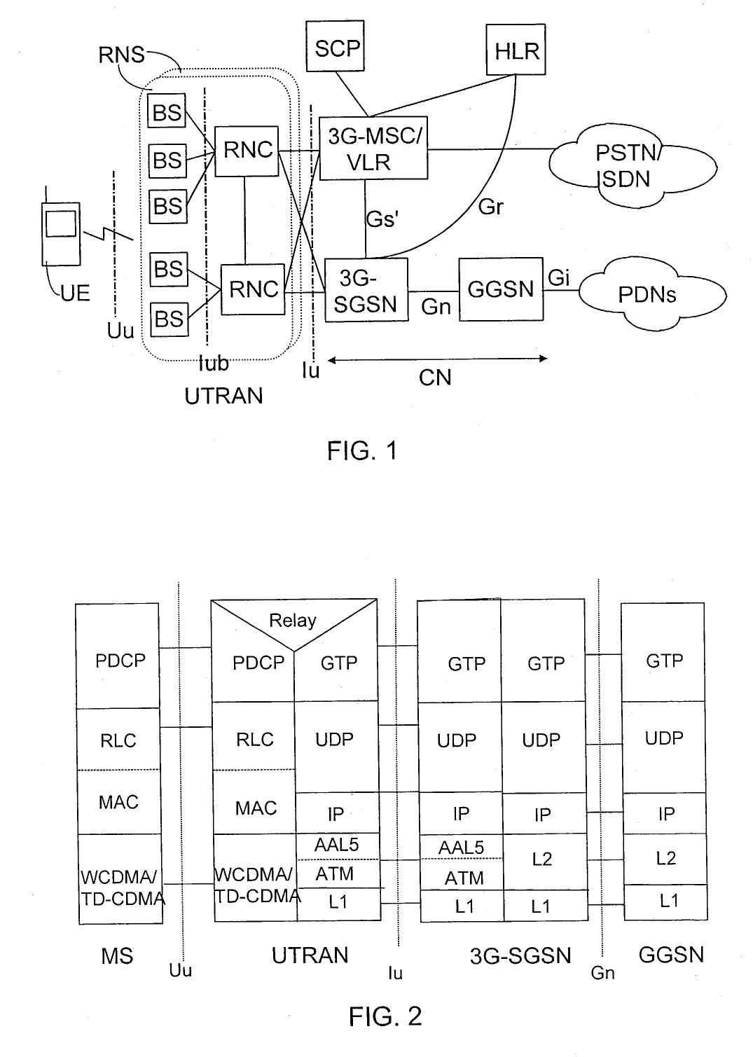

The structure of the UMTS mobile communication system will be described with reference to FIG. 1. FIG. 1 includes only the blocks relevant to describing the invention but it is obvious to a person skilled in the art that a conventional mobile communication system also comprises other functions and structures that need not be explained more closely in this context. The main elements of a mobile communication system are a core network CN and a UMTS terrestrial radio access network UTRAN, which form the fixed network of the mobile communication system, and a mobile station or user equipment UE. The interface between the CN and the UTRAN is called lu and the interface between the UTRAN and the UE is known as Uu.

The UTRAN typically consists of several radio network sub-systems RNS between which there is an interface called lur (not shown). The RNS consists of radio network controllers RNC and one or more base stations BS, which are also called node Bs. The interface between the RNC and the BS is called lub. The base station BS is typically responsible for implementation of the radio path, and the radio network controller RNC at least for the following matters: radio resource management, controlling of handover between cells, power control, timing and synchronization, paging of subscriber terminals.

The core network CN consists of infrastructure belonging to a mobile communication system outside the UTRAN. In the core network, a mobile switching centre/visitor location register 3G-MSCNLR communicates with a home location register HLR and preferably also with a service control point SCP of the intelligent network. The home location register HLR and the visitor location register VLR contain information on mobile subscribers: the home location register HLR contains information on all subscribers of the mobile communication network and on the services ordered by them, and the visitor location register VLR contains information on mobile stations which visit the area of a certain mobile switching centre MSC. The connection to a serving GPRS support node 3G-SGSN of the radio system is established via a Gs′ interface and to a public switched telephone network PSTN/ISDN via a gateway mobile switching centre GMSC (Gateway MSC, not shown). A connection is established from the serving support node 3G-SGSN to the gateway GPRS support node GGSN via a Gn interface, and further from the GGSN to external data networks PDN. Both the mobile switching centre 3G-MSCNLR and the serving support node 3G-SGSN communicate with the radio network UTRAN (UMTS Terrestrial Radio Access Network) via the lu interface. It should be noted that the UMTS system is designed so that the core network CN may be identical with the core network of the GSM system, for example, in which case the whole network infrastructure does not need to be rebuilt.

The UMTS system thus also comprises a packet radio system which is implemented to a great extent in accordance with the GPRS system connected to the GSM network, for which reason the names of the network elements contain references to the GPRS system. The packet radio system of the UMTS may comprise several serving support nodes and gateway support nodes, and typically several serving support nodes 3G-SGSN are connected to one gateway support node 3G-GGSN. Both the 3G-SGSN node and the 3G-GGSN node function as routers which support mobility of the mobile station and control the mobile communication system and route data packets to mobile stations regardless of their location and the protocol used. The serving support node 3G-SGSN communicates with a mobile station MS via the radio network UTRAN. The function of the serving support node 3G-SGSN is to detect mobile stations capable of packet radio connections in its area, send data packets to and receive them from these mobile stations and to monitor the location of the mobile stations in its service area. In addition, the serving support node 3G-SGSN communicates with the mobile switching centre 3G-MSC and the visitor location register VLR via the signalling interface Gs′ and with the home location register HLR via the Gr interface. The home location register HLR also contains records which are related to the packet radio service and include the contents of subscriber-specific packet data protocols.

The gateway support node 3G-GGSN functions as a gateway between the packet radio system of the UMTS network and an external data network PDN (Packet Data Network). External data networks include a UMTS or a GPRS network of another network operator, the Internet, an X.25 network or a private local area network. The gateway support node 3G-GGSN communicates with these data networks via a Gi interface. The data packets to be transmitted between the gateway support node 3G-GGSN and the serving support node 3G-SGSN are always encapsulated according to a GPRS tunnelling protocol GTP. The gateway support node 3G-GGSN also contains the PDP addresses (Packet Data Protocol) of mobile stations and the routing data, i.e. 3G-SGSN addresses. Thus the routing data are used for linking data packets between the external data network and the serving support node 3G-SGSN. The network between the gateway support node 3G-GGSN and the serving support node 3G-SGSN is a network which utilizes the IP protocol, preferably IPv6 (Internet Protocol, version 6).

In the UMTS, a protocol stack according to FIG. 2 is used in the transmission of packet-switched user data (user plane). At the interface Uu between the radio network UTRAN and the mobile station MS, lower-level data transmission is carried out according to the WCDMA or TD-CDMA protocol in the physical layer. Data packets are transmitted between the physical layer and the RLC layer (Radio Link Control) by a MAC layer (Media Access Layer) which is above the physical layer, and the RLC layer is responsible for logical management of radio links of different radio bearers. The functionalities of the RLC include segmentation of user data to be transmitted (RLC-SDU, Service Data Unit) into one or more RLC data packets RLC-PDU. The data packets (PDCP-PDU) of the PDCP layer on top of the RLC and the header fields related to them can be compressed, if desired. After this, the PDCP-PDUs, which correspond to one RLC-SDU, are supplied to the RLC. The user data and the RLC-SDUs are segmented and transmitted in RLC frames to which address and control information necessary for data transmission has been added. The RLC layer is also responsible for retransmission of damaged frames. The serving support node 3G-SGSN is responsible for routing the data packets arriving from the mobile station MS via the radio network RAN further to the correct gateway support node 3G-GGSN. This connection uses the tunnelling protocol GTP, which encapsulates and tunnels all the user data and signalling transmitted via the core network. The GTP protocol is run above the IP used by the core network.

One of the functions of the PDCP layer is to enable transmission of data packets PDCP-SDU received from the upper application-level layers further to lower link-level layers and vice versa transparently between the UMTS terminals and the elements of the radio network UTRAN. Thus the PDCP layer has to be adaptable so that it can also transmit data packets according to other network level protocols than the known IP protocols (IPv4, IPv6).

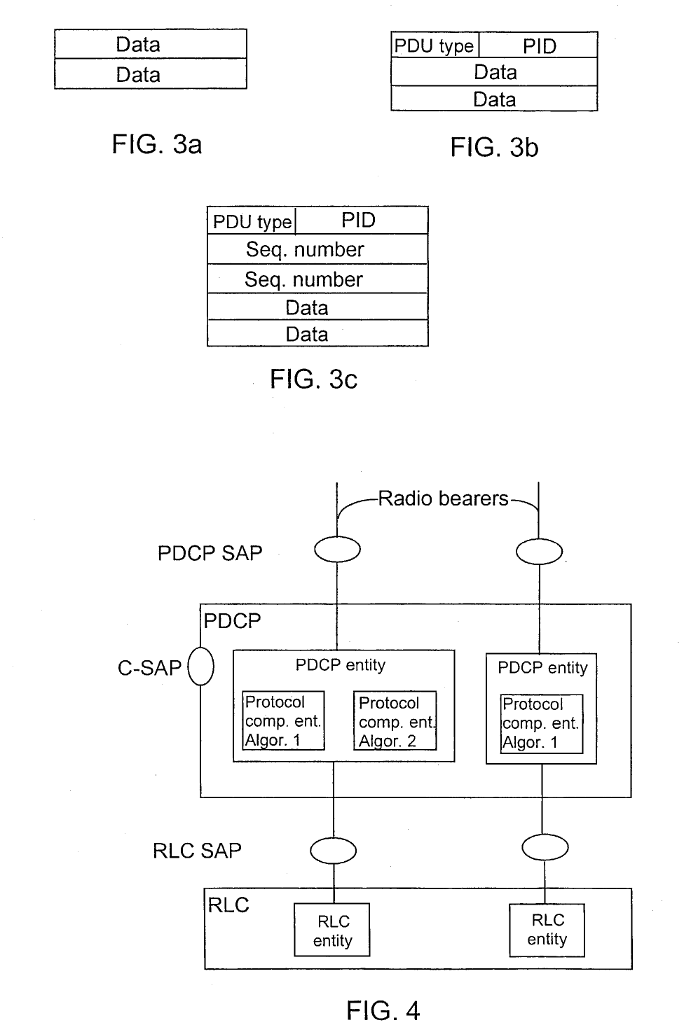

The information included in the data packets PDCP-SDU arriving from the upper application-level layers can be forwarded from the PDCP layer using three different data packets PDCP-PDU: PDCP-No-Header-PDU, PDCP-Data-PDU and PDCP-SeqNum-PDU, which are illustrated in FIGS. 3a, 3b and 3c, respectively.

According to FIG. 3a, the PDCP-No-Header-PDU comprises only data, i.e. the PDCP-SDU received from the upper layers as such. Thus the PDCP layer does not add any information to the PDCP-SDU, in which case the whole PDCP-PDU is used for transmitting payload.

One byte (8 bits) has been added to the PDCP-Data-PDU of FIG. 3b to indicate the PDU type in question and the compression method to be applied to the header field of the PDCP-SDU. In fact, the tasks of the PDCP layer include functions related to improvement of channel capacity, which are typically based on optimisation of data packet header fields by means of various compression algorithms. Since nowadays the network level protocols designed for the UMTS are IP protocols, the compression algorithms to be used are also algorithms standardised by the IETF (Internet Engineering Task Force). If necessary, any header field compression algorithm can be applied in the PDCP layer, the algorithm being naturally selected according to the network level protocol used.

The PDCP-SeqNum-PDU of FIG. 3c also comprises a corresponding extra byte for indicating the PDU type and the compression method to be applied to the PDCP-SDU header field. In addition to this, a PDCP-PDU sequence number with a length of two bytes, i.e. 16 bits, has been added to it. One of the functions of the PDCP layer is to transmit data packets PDCP-PDU and, if necessary, PDCP sequence numbers related to the packets to a new radio network subsystem in SRNS relocation between radio network subsystems in the UMTS. Both in the PDCP-Data-PDU and in the PDCP-SeqNum-PDU the PDU type is indicated with three bits, and thus it separates the PDCP-Data-PDU from the PDCP-SeqNum-PDU. The compression method to be used is indicated with five bits.

FIG. 4 shows a functional model of the PDCP layer in which one PDCP entity is defined for each radio bearer. Since in the existing systems a separate PDP context is defined for each radio bearer, one PDCP entity is also defined for each PDP context, and thus a certain RLC entity is defined for the entity in the RLC layer. In principle, the functions of the PDCP layer can be implemented by multiplexing several PDP contexts in the PDCP layer, in which case one RLC entity in the RLC layer below the PDCP layer receives data packets simultaneously from several radio bearers.

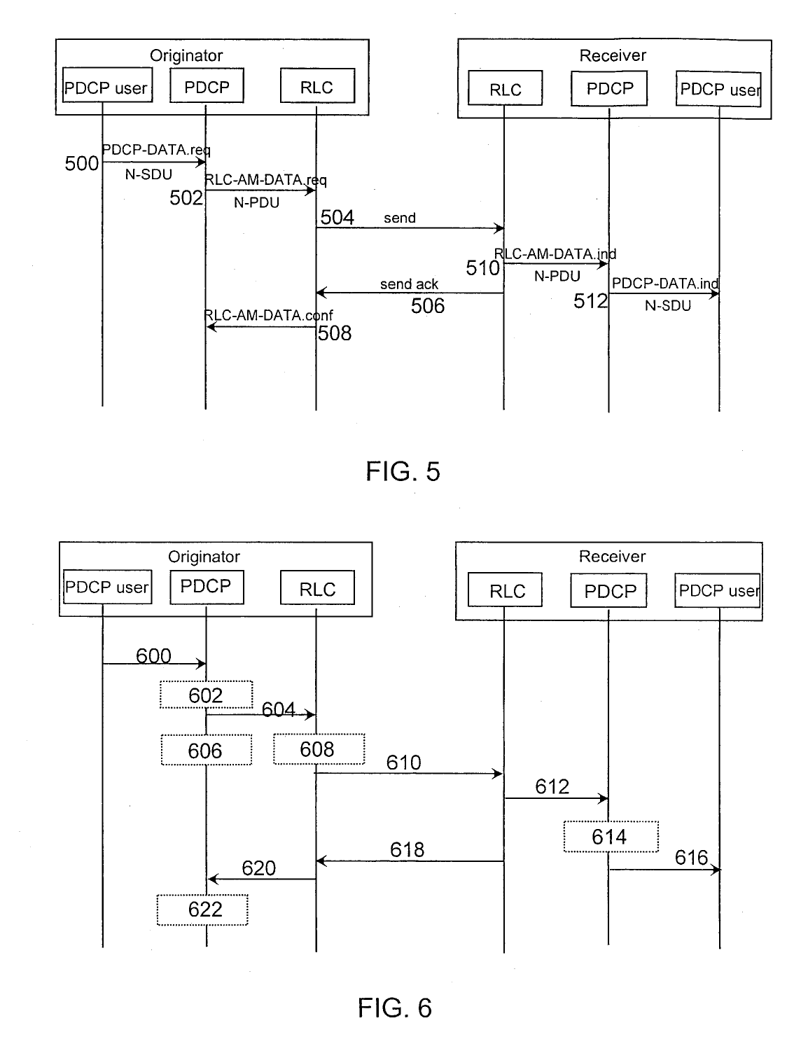

FIG. 5 shows how data transmission is acknowledged and how data packets travel when acknowledged transmission is used in PDCP data transmission. The PDCP entity receives a request (PDCP-DATA.request, 500) to transmit data packets from the user as well as data packets PDCP-PDU together with the request. The PDCP entity compresses the header fields of the data packets and sends the resulting data packets PDCP-PDU to the RLC layer (RLC-AM-DATA.request, 502) together with the identity data of the radio link. The RLC layer is responsible for transmitting (send, 504) data packets PDCP-PDU and for acknowledging successful transmission (send ack, 506). In the PDCP entity the data packets PDCP-SDU are inserted into a buffer, from which they are not removed until an acknowledgement (RLC-AM-DATA.conf, 508) of successful transmission of data packets to the receiver is received from the RLC layer. The receiving PDCP receives the PDCP-PDUs transmitted from the RLC layer (RLC-AM-DATA.indication, 510), in which case the PDCP entity decompresses the data packets PDCP-PDU. Thus the original data packets PDCP-SDU can be restored and will be forwarded to the user (PDCP-DATA.indication, 512).

In this connection it is possible to apply virtual numbering of data packets, which means that no separate data packet numbers are added to the data packets, but the counters are updated on the basis of the transmitted data packets and the receiving PDCP and the transmitting PDCP can ascertain successful transmission of data packets on the basis of counter values.

In virtual data packet numbering, a PDCP-PDU sequence number is defined for the first data packet of the packet data connection and a predetermined numerical value, e.g. 0, is set as the initial value for this number in the counter both in the transmitting PDCP and in the receiving PDCP. Data packet numbering is illustrated in greater detail in FIG. 6. When the transmitting PDCP receives (600) a data packet PDCP-SDU from the sender, it inserts the data packet into the PDCP-SDU buffer and logically adds a PDCP-PDU sequence number (602) to this data packet. The transmitting PDCP transmits the data packet PDCP-PDU and the PDCP-PDU sequence number logically attached to it to the RLC layer (604) and adds one (606) to the counter that determines the value of the PDCP-PDU sequence number. The RLC layer may also optionally define the ratio between the PDCP-PDU sequence number and the last RLC sequence number of the data packet and store in memory (608). The RLC layer is responsible for transmission of PDCP-PDU data packets between the sender and the receiver (610), the data packets PDCP-PDU being split into data units RLC-PDU for transmission and numbered with RLC sequence numbers. When the receiving PDCP receives (612) a data packet PDCP-PDU from the RLC layer, it adds one (614) to the counter that defines the value of the PDCP-PDU sequence numbers and transmits the data packet PDCP-SDU to the next layer (616). An acknowledgement of a successfully received data packet is sent to the sender (618) in the RLC layer, and the sender-RLC transmits this acknowledgement to the transmitting PDCP (620). In response to the acknowledgement, the transmitting PDCP removes the data packet PDCP-SDU in question from the buffer (622). The correct data packet PDCP-SDU to be removed is determined preferably by means of a PDCP-PDU sequence number logically attached to the data packet.

When the radio bearer is established (RB establishment) or reconfigured, the terminal and the radio network negotiate the parameters of the radio bearer using signalling according to a radio resource control protocol RRC. The radio resource control protocol RRC is responsible e.g. for establishing, configuring, maintaining and terminating radio connections between the mobile station and the radio network UTRAN and for transmitting control information transmitted from the core network CN and the radio network RAN to the mobile stations MS. Thus the RRC signalling is used for deciding e.g. which one of the above-mentioned three PDCP-PDUs is used on the radio bearer in question. Furthermore, the RRC signalling is used for determining whether the radio bearer requires lossless SRNS relocation between the radio network subsystems. Lossless relocation, in which data packets are not lost in the handover process, is needed in reliable data transmission which utilizes acknowledged transmission. This sets certain requirements for the RLC layer of the UMTS system: the RLC layer has to be in the acknowledge mode and the RLC must be able to send the data packets in-sequence.

The virtual data packet numbering described above also supports lossless relocation between radio network subsystems, in which case acknowledgement of data packets can also be made to correspond to the acknowledgement of data packets in normal PDCP data transmission described above. In other words, virtual data packet numbering can also be used in normal acknowledged data transmission, in which the receiver and the sender remain the same, whereas in the handover process one party changes. Since data packet numbers need not be sent between the receiving PDCP and the transmitting PDCP when virtual data packet numbering is used, a PDCP-No-Header-PDU can advantageously be used for data transmission. The PDCP-No-Header-PDU does not contain any header field or attached data packet numbers; instead, the whole data packet is reserved for transmitting payload.

In some interference situations, e.g. when the network is congested or there is disturbance on the radio path, the RLC layer cannot guarantee acknowledged data transmission. A maximum value is typically defined for the sender-RLC, which is either a number of retransmissions or a period during which the sender-RLC tries to retransmit the same data packet. If the maximum value is exceeded, the RLC layer informs the receiving PDCP of this. The transmitting PDCP removes the corresponding data packet from the buffer in connection with the next successful data packet transmission. This also happens when several successive data packets have been lost. The lost data packets are removed from the buffer when an acknowledgement of the next successfully transmitted data packet is received. However, the rejection process of the RLC layer described above may also trigger removal of data packets from the buffer without an acknowledgement of the next successfully transmitted data packet. If the RLC can inform the PDCP layer of all lost data packets, the receiving PDCP can update the PDCP-PDU sequence number correctly, and thus the sequence number counters of the transmitting PDCP and the receiving PDCP remain synchronized. However, in some interference situations the RLC layer cannot guarantee that the PDCP layer is informed of lost data packets, in which case the PDCP-PDU sequence number counters may become asynchronous in the transmitting PDCP and receiving PDCP. In such situations the radio bearer or the connection between the RLC layers typically has to be reconfigured, and consequently synchronization of sequence number counters is lost permanently. Reconfiguration of the radio bearer or the connection between the RLC layers typically has to be performed always during the handover between radio network subsystems. Asynchronization of the sequence number counters constitutes a problem particularly when a PDCP-No-Header-PDU which does not comprise any information for re-synchronizing the PDCP-PDU sequence number counters in the transmitting PDCP and the receiving PDCP is to be used on the radio bearer to be acknowledged.

This asynchronization can be corrected according to the invention by momentarily using in data transmission PDCP-SeqNum-PDUs which also comprise a data packet number which identifies the data packet. In that case some mechanism has to be used between the transmitting PDCP and the receiving PDCP for finding out how many PDCP-SeqNum-PDUs are transmitted and when PDCP-No-Header-PDUs can be used again. This should be indicated consistently both to the transmitting PDCP and the receiving PDCP to allow simultaneous switch from one PDCP-PDU type to another because the receiving PDCP cannot conclude only on the basis of the received PDCP-PDU data packets what kind of data packets have been sent.

According to a preferred embodiment, the above-mentioned RRC signalling for determining the radio bearer is used for determining the number of PDCP-SeqNum-PDUs to be sent. Thus a new parameter is preferably added to the RRC signalling used in the establishment of the radio bearer, the parameter defining how many PDCP-SeqNum-PDUs the transmitting PDCP has to send during reconfiguration of the radio bearer or the connection between the RLC layers. When the radio bearer is established, the transmitting PDCP and the receiving PDCP negotiate by means of RRC signalling that N PDCP-SeqNum-PDU data packets are always sent first when the radio bearer or the connection between the RLC layers is being reconfigured, after which PDCP-No-Header-PDU data packets are sent again. When reconfiguration has to be performed for one reason or another, the transmitting PDCP sends the above-mentioned N PDCP-SeqNum-PDU data packets, which contain a data packet number and by means of which the receiving PDCP can synchronize its PDCP-PDU sequence number counter so that it corresponds to the PDCP-PDU sequence number counter of the transmitting PDCP. Both the transmitting PDCP and the receiving PDCP count the PDCP-SeqNum-PDUs to be transmitted and after N PDCP-SeqNum-PDU data packets have been sent, the transmitting PDCP starts to send PDCP-No-Header-PDUs. Correspondingly, the receiving PDCP correspondingly is prepared for receiving PDCP-No-Header-PDU after N PDCP-SeqNum-PDUs have been received.

Consequently, both the transmitting PDCP and the receiving PDCP have accurate information on how many PDCP-SeqNum-PDUs are to be sent and when data transmission can be continued by means of PDCP-No-Header-PDUs. A terminal may have several simultaneous radio bearers, in which case variable N can be defined separately for each radio bearer, which enables flexible utilization of radio resources.

According to the second embodiment, a constant value is set for the number of PDCP-SeqNum-PDUs to be sent during reconfiguration of the radio bearer or the connection between RLC layers, and this constant value is used on all radio bearers on which PDCP-No-Header-PDUs should have been used according to the original negotiation. Thus both the transmitting PDCP and the receiving PDCP know about the constant value in advance and need not negotiate about it e.g. during RRC signalling. This facilitates implementation of the mobile communication systems because the constant value can be simply programmed in advance for all terminals and necessary radio network elements.

According to the third embodiment, the transmitting PDCP and the receiving PDCP do not negotiate in advance about the number of PDCP-SeqNum-PDUs to be sent during reconfiguration of the radio bearer or the connection between the RLC layers, but PDCP-SeqNum-PDU data packets are sent according to a default value always after configuration. The transmitting PDCP sends these PDCP-SeqNum-PDUs, which also include a data packet number which identifies the data packet, until a bit or a bit combination in the header field of the data packet indicates that the data packet to be sent next is a PDCP-No-Header-PDU. For example, the three-bit PDU type field of the header field shown in FIG. 3c can be used for this purpose. At the moment, only two out of the eight different combinations of the type field are reserved. When the receiving PDCP receives a PDCP-SeqNum-PDU comprising the above-mentioned bit or bit combination, it prepares for receiving a PDCP-No-Header-PDU next.

The number of the PDCP-SeqNum-PDU data packets to be sent in connection with the first and the third embodiment is preferably determined separately for each radio bearer. This number is preferably determined according to the properties of the radio interface of the radio bearer, in which case significant parameters may be e.g. the bit rate used or the bit error rate BER of the radio connection. Since the radio resource control protocol RRC knows how different protocol layers of the radio interface have been configured, the RRC may give directions to the PDCP layer about how many PDCP-SeqNum-PDU data packets are to be sent. In the third embodiment it is also possible to switch to continuous PDCP-No-Header-PDU transmission when the receiving PDCP can send an acknowledgement of the fact that the receiving PDCP sequence number counter has been synchronized.

According to the fourth embodiment, the PDCP-SeqNum-PDUs to be sent during reconfiguration of the radio bearer or the RLC reset are sent alternately with PDCP-No-Header-PDUs according to a predetermined algorithm. For example, 10 data packets can be defined to be sent so that every other data packet is a PDCP-SeqNum-PDU and every other a PDCP-No-Header-PDU, and after the ten data packets transmission is continued with PDCP-No-Header-PDUs. The algorithm to be used may also be considerably more complicated than the alternation described above. This embodiment minimizes the number of PDCP-SeqNum-PDU data packets to be sent, and yet guarantees synchronization of the sequence number counters. Before switching to the continuous transmission of PDCP-No-Header-PDUs the number of data packets to be sent can be determined according to any of the three alternatives described: negotiating about the number and preferably also about the algorithm in advance by means of RRC signalling; setting a constant value for the number and the algorithm; or indicating during the transmission that it will continue as continuous PDCP-No-Header-PDU transmission.

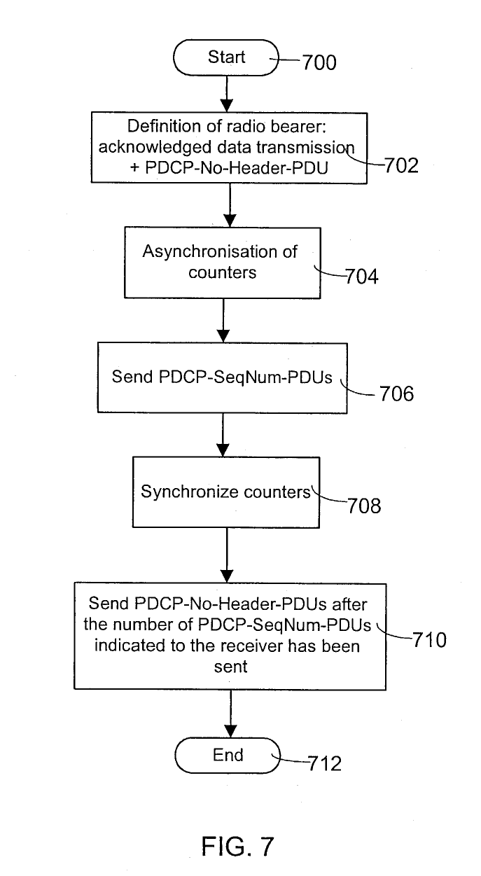

In the following the invention will be described with reference to FIG. 7. When a radio bearer is established, a definition (702) is performed on it by means of the RRC signalling described above. In the case of the invention the radio bearer is defined to use acknowledged data transmission and PDCP-No-Header-PDU data packets. The RRC signalling also defines other parameters for the radio bearer, but they are not relevant to the invention. When the data packet counters become asynchronous (704), e.g. due to handover between radio network subsystems, the sender switches to sending PDCP-SeqNum-PDU data packets in the PDCP layer (706), which also include a data packet number which identifies the data packet. These data packet numbers are used for synchronizing the data packet counters of the transmitting PDCP and the receiving PDCP (708). When the receiving PDCP receives the transmitted PDCP-SeqNum-PDU data packets and the data packet numbers included in them, it compares the data packet numbers with the counter values, and, if necessary, updates the counter value to correspond to the data packet numbers of the received data packets. A certain number of PDCP-SeqNum-PDU data packets are sent, after which PDCP-No-Header-PDU data packets originally defined for the radio bearer will be sent again (710). The above-mentioned number of PDCP-SeqNum-PDU data packets to be sent is indicated to the receiver preferably in one of the three ways described above. Thus the indication may take place during definition (702) of the radio bearer, in the last PDCP-SeqNum PDU data packet to be sent (710), or the transmitting PDCP and the receiving PDCP may know the number before the radio bearer is defined (700).

It is obvious to a person skilled in the art that as the technology advances, the inventive concept can be implemented in various ways. The invention and its embodiments are thus not limited to the examples described above but may vary within the scope of the claims.

1. A method for acknowledged transmission of data packets in a packet-switched telecommunications system, the telecommunications protocol of which comprises a convergence protocol layer for converting user data packets into convergence protocol packets, and a link layer for sending convergence protocol packets as data units and for acknowledging the transmission, the method comprising
defining a data packet number for the convergence protocol packets to be transmitted by means of counters of the sender and the receiver which are synchronized with each other, in which case the transmitted convergence protocol packets are acknowledged with said counter values,
defining that convergence protocol packets containing only user data are to be used in the data transmission between the sender and the receiver,
sending, in response to asynchronization of said counters, convergence protocol packets which contain a packet data number, and indicating the number of said convergence protocol packets to the receiver, and
synchronizing said counters on the basis of the data packet numbers included in said convergence protocol packets.

2. A method according to claim 1, further comprising
continuing transmission of convergence protocol packets which include only user data after said number of convergence protocol packets with a data packet number have been sent.

3. A method according to claim 1, further comprising
indicating the number of convergence protocol packets which are to be sent and include a data packet number to the receiver with signalling according to a radio resource control protocol which defines the radio bearer.

4. A method according to claim 3, further comprising
defining the number of convergence protocol packets which are to be sent and include a data packet number separately for each radio bearer.

5. A method according to claim 1, further comprising
indicating the number of convergence protocol packets which are to be sent and include a data packet number to the receiver as a predetermined default value.

6. A method according to claim 5, further comprising
using said default value as the number of convergence protocol packets which are to be sent and include a data packet number on each radio bearer.

7. A method according to claim 1, further comprising
defining the number of convergence protocol packets which are to be sent and include a data packet number, and indicating this number to the sender's convergence protocol layer, and
indicating the last convergence protocol packet which is to be sent and includes a data packet number to the receiver by means of at least one predetermined bit included in the header field in said convergence protocol packet.

8. A method according to claim 7, further comprising
determining the number of convergence protocol packets which are to be sent and include a data packet number separately for each radio bearer.

9. A method according to claim 1, further comprising
sending convergence protocol packets including a data packet number alternately with convergence protocol packets which include only user data according to a predetermined algorithm, which defines the duration of the turns.

10. A method according to claim 1, further comprising
sending convergence protocol packets including a data packet number in response to performing a certain process of the telecommunications system, such as reconfiguration of the radio bearer or a connection between the RLC layers.

11. A method according to claim 1, wherein
said telecommunications system is a packet-switched mobile communication system, such as the UMTS system, which utilizes acknowledged transmission.

12. A method according to claim 11, wherein
the method is applied in handover between radio network subsystems of the UMTS.
